(19) United States
(12) Patent Application Publication
(10) Pub. No.: US 2005/0130017 A1
(43) Pub. Date: Jun. 16, 2005

(54) Fuel cell plate

(76) Inventors: Zhiqiang Xu, Bloomfield, NJ (US); Zhigang Qi, North Arlington, NJ (US); Arthur Kaufman, West Orange, NJ (US)

Correspondence Address: FISH & RICHARDSON PC, 225 FRANKLIN ST, BOSTON, MA, 02110, US

(21) Appl. No.: 10/736,156

(22) Filed: Dec. 15, 2003

(51) Int. Cl. H01M 2/08; H01M 2/14

(52) U.S. Cl. 429/36; 429/38

(57) ABSTRACT

Fuel cell plates, and related systems and methods are disclosed.

### TECHNICAL FIELD

The invention relates to fuel cell plates, and related systems and methods.

### BACKGROUND

A fuel cell can convert chemical energy to electrical energy by promoting electrochemical reactions of two reactants.

One type of fuel cell includes a cathode flow field plate, an anode flow field plate, a membrane electrode assembly disposed between the cathode flow field plate and the anode flow field plate, and diffusion layers disposed between the cathode flow field plate and the anode flow field plate. A fuel cell can also include one or more coolant flow field plates disposed adjacent the exterior of the anode flow field plate and/or the exterior of the cathode flow field plate.

Each reactant flow field plate has an inlet region, an outlet region and open-faced channels connecting the inlet region to the outlet region and providing a way for distributing the reactants to the membrane electrode assembly.

The membrane electrode assembly usually includes a solid electrolyte (e.g., a proton exchange membrane) between a first catalyst and a second catalyst. One diffusion layer is between the first catalyst and the anode flow field plate, and another diffusion layer is between the second catalyst and the cathode flow field plate.

During operation of the fuel cell, one of the reactants (the anode reactant) enters the anode flow field plate at the inlet region of the anode flow field plate and flows through the channels of the anode flow field plate toward the outlet region of the anode flow field plate. The other reactant (the cathode reactant) enters the cathode flow field plate at the inlet region of the cathode flow field plate and flows through the channels of the cathode flow field plate toward the cathode flow field plate outlet region.

As the anode reactant flows through the channels of the anode flow field plate, some of the anode reactant passes through the anode diffusion layer and interacts with the anode catalyst. Similarly, as the cathode reactant flows through the channels of the cathode flow field plate, some of the cathode reactant passes through the cathode diffusion layer and interacts with the cathode catalyst.

The anode catalyst interacts with the anode reactant to catalyze the conversion of the anode reactant to reaction intermediates. The reaction intermediates include ions and electrons. The cathode catalyst interacts with the cathode reactant and the anode reaction intermediates to catalyze the conversion of the cathode reactant to the chemical product of the fuel cell reaction.

The chemical product of the fuel cell reaction flows through a diffusion layer to the channels of a flow field plate (e.g., the cathode flow field plate). The chemical product then flows along the channels of the flow field plate toward the outlet region of the flow field plate.

The electrolyte provides a barrier to the flow of the electrons and reactants from one side of the membrane electrode assembly to the other side of the membrane electrode assembly. However, the electrolyte allows ionic reaction intermediates to flow from the anode side of the membrane electrode assembly to the cathode side of the membrane electrode assembly.

Therefore, the ionic reaction intermediates can flow from the anode side of the membrane electrode assembly to the cathode side of the membrane electrode assembly without exiting the fuel cell. In contrast, the electrons flow from the anode side of the membrane electrode assembly to the cathode side of the membrane electrode assembly by electrically connecting an external load between the anode flow field plate and the cathode flow field plate. The external load allows the electrons to flow from the anode side of the membrane electrode assembly, through the anode flow field plate, through the load and to the cathode flow field plate, and the cathode side of the membrane electrode assembly.

Because electrons are formed at the anode side of the membrane electrode assembly, the anode reactant undergoes oxidation during the fuel cell reaction. Because electrons are consumed at the cathode side of the membrane electrode assembly, the cathode reactant undergoes reduction during the fuel cell reaction.

For example, when molecular hydrogen and molecular oxygen are the reactants used in a fuel cell, the molecular hydrogen flows through the anode flow field plate and undergoes oxidation. The molecular oxygen flows through the cathode flow field plate and undergoes reduction. The specific reactions that occur in the fuel cell are represented in equations 1-3.
H₂→2H⁺+2e⁻ (1)
1/2O₂+2H⁺+2e⁻→H₂O (2)
H₂+1/2O₂→H₂O (3)

As shown in equation 1, the molecular hydrogen forms protons (H⁺) and electrons. The protons flow through the electrolyte to the cathode side of the membrane electrode assembly, and the electrons flow from the anode side of the membrane electrode assembly to the cathode side of the membrane electrode assembly through the external load. As shown in equation 2, the electrons and protons react with the molecular oxygen to form water. Equation 3 shows the overall fuel cell reaction.

In addition to forming chemical products, the fuel cell reaction produces heat. One or more coolant flow field plates are typically used to conduct the heat away from the fuel cell and prevent it from overheating.

Each coolant flow field plate has an inlet region, an outlet region and channels that provide fluid communication between the coolant flow field plate inlet region and the coolant flow field plate outlet region. A coolant (e.g., liquid de-ionized water) at a relatively low temperature enters the coolant flow field plate at the inlet region, flows through the channels of the coolant flow field plate toward the outlet region of the coolant flow field plate, and exits the coolant flow field plate at the outlet region of the coolant flow field plate. As the coolant flows through the channels of the coolant flow field plate, the coolant absorbs heat formed in the fuel cell. When the coolant exits the coolant flow field plate, the heat absorbed by the coolant is removed from the fuel cell.

To increase the electrical energy available, a plurality of fuel cells can be arranged in series to form a fuel cell stack. In a fuel cell stack, one side of a flow field plate functions as the anode flow field plate for one fuel cell while the opposite side of the flow field plate functions as the cathode flow field plate in another fuel cell. This arrangement may be referred to as a bipolar plate. The stack may also include monopolar plates such as, for example, an anode coolant flow field plate having one side that serves as an anode flow field plate and another side that serves as a coolant flow field plate. As an example, the open-faced coolant channels of an anode coolant flow field plate and a cathode coolant flow field plate may be mated to form collective coolant channels to cool the adjacent flow field plates forming fuel cells.

### SUMMARY

In one aspect, the invention features an article that includes a fuel cell flow plate having a sulfonic acid moiety covalently bonded thereto. The sulfonic acid moiety has the formula RSO₃H, where R is /, an alkyl moiety, an alkenyl moiety, an alkynyl moiety, an aryl moiety, or a heteroaryl moiety.

In another aspect, the invention features a fuel cell that includes two fuel cell flow plates and an electrolyte between the fuel cell flow plates. A sulfonic acid moiety is covalently bonded to at least one of the fuel cell flow plates. The sulfonic acid moiety has the formula RSO₃H, where R is /, an alkyl moiety, an alkenyl moiety, an alkynyl moiety, aryl moiety, or a heteroaryl moiety.

In a further aspect, the invention features an article that includes a fuel cell flow plate and an acidic moiety covalently bonded to the fuel cell flow plate. The acidic moiety has the formula R—X. R is /, an alkyl moiety, an alkenyl moiety, an alkynyl moiety, an aryl moiety, or a heteroaryl moiety. X is selected from SO₃H, PO₃H₂, AsO₃H₂ and COOH.

As used herein, the symbol “/” refers to a direct bond between the sulfur atom in the sulfonic acid moiety and the fuel cell flow plate.

As used herein, the term “alkyl moiety” refers to an unsaturated hydrocarbon chain that may be a straight chain or branched chain. In general, the number of carbon atoms in an alkyl moiety can be varied as desired (e.g., one to ten carbon atoms, one to six carbon atoms, one to three carbon atoms). An alkyl moiety can be substituted (e.g., substituted with one or more halogens) or unsubstituted.

As used herein, the term “halogen” refers to any radical of fluorine, chlorine, bromine or iodine.

As used herein, the term “alkenyl moiety” refers to a hydrocarbon chain having at least one carbon-carbon double bond. In general, the number of carbon atoms in an alkenyl moiety can be varied as desired (e.g., two to ten carbon atoms, two to six carbon atoms, two to three carbon atoms). An alkenyl moiety can be substituted (e.g., substituted with one or more halogens, substituted with one or more alkyl) or unsubstituted.

As used herein, the term “alkynyl moiety” refers to a hydrocarbon chain having at least one carbon-carbon triple bond. In general, the number of carbon atoms in an alkynyl moiety can be varied as desired (e.g., two to ten carbon atoms, two to six carbon atoms, two to three carbon atoms). An alkynyl moiety can be substituted (e.g., substituted with one or more halogens, substituted with one or more alkyl) or unsubstituted.

As used herein, the term “aryl” refers to a carbon-containing moiety having at least one aromatic ring. For example, an aryl moiety can contain at least one 6-carbon monocyclic aromatic ring and/or at least one 10-carbon bicyclic aromatic ring system. The atoms in the ring of an aryl moiety can be substituted (e.g., substituted with one or more halogens, substituted with one or more alkyl) or unsubstituted.

As used herein, the term “heteroaryl” refers to a carbon-containing moiety that has at least one aromatic ring with at least one non-carbon atom (e.g., O, S, N) in the ring. Examples of heteroaryls include: aromatic 5-8 membered monocyclic rings with at least one O, S and/or N in the ring; 8-12 membered bicyclic rings with at least one O, S and/or N in the ring; and 11-14 membered tricyclic rings with at least one O, S and/or N in the ring. Generally, for monocyclic ring systems, the number of non-carbon atoms in the ring is one, two or three; for bicyclic rings, the number of non-carbon atoms in the ring is one, two, three, four, five or six; for tricyclic rings, the number of non-carbon atoms in the ring is one, two, three, four, five, six, seven, eight or nine.

Embodiments can have one or more of the following features.

In some embodiments, R is / (i.e., the sulfonic acid moiety is directly bonded to the fuel cell flow plate).

In certain embodiments, R is an alkyl moiety that is substituted with one or more halogens.

In some embodiments, R is an aryl moiety that is substituted with one or more halogens and/or one or more alkyl moieties.

In certain embodiments, the fuel cell flow plate is formed of carbon (e.g., graphite).

In some embodiments, the hydrophilicity of the article is greater than the hydrophilicity of the fuel cell flow plate.

In certain embodiments, the fuel cell flow plate is porous. In such embodiments, the sulfonic acid moiety can be present in pores of the fuel cell flow plate.

In some embodiments, the fuel cell flow plate is non-porous.

In certain embodiments, the fuel cell flow plate is a bipolar flow plate, a monopolar plate or a coolant plate.

In some embodiments, at least about 90% of the surface area of the fuel cell flow plate has the sulfonic acid moiety covalently bonded thereto.

In certain embodiments, the surface of the flow-field channel portion of the fuel cell flow plate is covalently bonded to the sulfonic acid moiety.

In some embodiments, the surface of the land portion of the fuel cell flow field plate is substantially devoid of the sulfonic acid moiety.

In certain embodiments, at least a portion of the surface of the article has an initial contact angle with water that is less than about 75°.

In some embodiments, at least a portion of the surface of the article has an initial contact angle with diiodomethane that is less than about 40°.

In certain embodiments, at least a portion of a surface of the article has an initial contact angle with water that is at least about 15° less than an initial contact angle with water of the fuel cell flow plate.

In some embodiments, at least a portion of a surface of the article has an initial contact angle with water that is at least about 20% less than an initial contact angle with water of the fuel cell flow plate.

In some embodiments, the fuel cell is a proton-exchange-membrane fuel cell or a direct-feed liquid fuel cell (e.g., a direct alcohol fuel cell, such as a direct methanol fuel cell).

Embodiments can provide one or more of the following advantages.

In some embodiments, the fuel cells exhibit reduced flooding during use. Without wishing to be bound by theory, it is believed that the flooding may be reduced because the sulfonic acid moiety can increase the hydrophilicity of portions of a fuel cell flow plate that are in contact with water. It is believed that the increased hydrophilicity can cause water to spread more easily on the portions of the fuel cell flow plate in contact with the water, thereby increasing the surface area of the water and allowing for quicker evaporation of the water.

In certain embodiments, the sulfonic acid moiety is short enough so that the sulfonic acid moiety does not substantially impede the-flow of electrons within the fuel cell.

In some embodiments, the presence of the sulfonic acid moiety can enhance the durability of the fuel cell flow plate, thereby increasing the useful life of the fuel cell flow plate and a fuel cell having the fuel cell flow plate incorporated therein.

Other features and advantages will be apparent from the description, drawings and from the claims.

### DESCRIPTION OF DRAWINGS

FIG. 1 is a cross-sectional view of an embodiment of a fuel cell.

FIG. 2 is an elevational view of an embodiment of an anode flow field plate.

FIG. 3 is an elevational view of an embodiment of a cathode flow field plate

FIG. 4 is an elevational view of an embodiment of a coolant flow field plate

FIG. 5a is a diagram of the location on a fuel cell flow plate where contact angle measurements were obtained.

FIG. 5b is a pictorial showing the contact angle θ of a water drop on a surface of a fuel cell flow plate.

FIG. 6a is a picture of an unsulfonated composite graphite plate taken using scanning electron microscopy.

FIG. 6b is a picture of a sulfonated composite graphite plate taken using scanning electron microscopy.

FIG. 7a is a plot of an X-ray emission analysis of an unsulfonated composite graphite plate.

FIG. 7b is a plot of an X-ray emission analysis of an sulfonated composite graphite plate.

### DETAILED DESCRIPTION

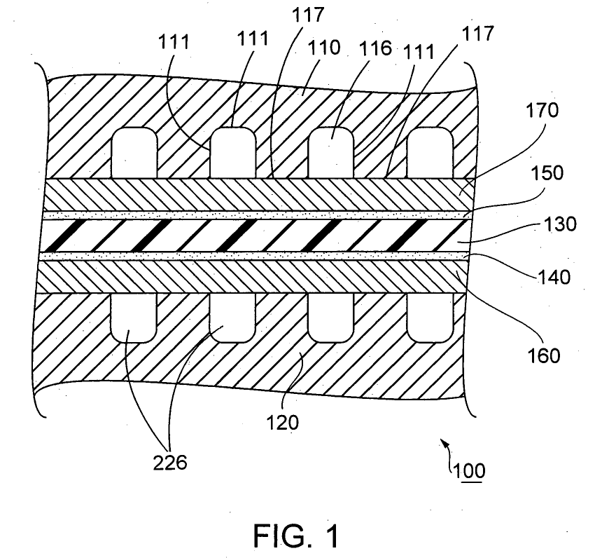

FIG. 1 shows a fuel cell 100 that includes a cathode flow field plate 110, an anode flow field plate 120, an electrolyte 130, catalysts 140 and 150, and diffusion layers 160 and 170.

Cathode flow field plate 110 is made from a carbon containing material (e.g., graphite, such as porous graphite or non-porous graphite), and surfaces 111 of open-face channels 116 of cathode flow field plate 110 have covalently bonded thereto sulfonic acid moieties (RSO₃H), where R is /, an alkyl moiety, an alkenyl moiety, an alkynl moiety, aryl moiety, or a heteroaryl moiety.

In some embodiments, a sulfonic acid moiety can be directly covalently bonded to surface 111 (R is /).

In certain embodiments, a sulfonic acid moiety can be indirectly covalently bonded to surface 111. In such embodiments R represents a linker moiety that is present between surface 111 and the sulfur atom in the sulfonic acid moiety. In general, a linker moiety can be any moiety capable of covalently bonding —SO₃H to surface 111. In embodiments in which plate 110 is formed of carbon, the structure can be represented by C-linker-SO₃H. Examples of linker moieties include alkyl moieties (e.g., C₁-C₁₀ alkyl, C₁-C₆ alkyl, C₁-C₃ alkyl), alkenyl moieties (e.g., C₂-C₁₀ alkenyl, C₂-C₆ alkenyl, C₂-C₃ alkenyl), alkynyl moieties (e.g., C₂-C₁₀ alkynyl, C₂-C₆ alkynyl, C₂-C₃ alkynyl), aryl moieties, and heteroaryl moieties. In some instances, multiple linker moieties can be used with one or more heteroatoms, such as, for example, O, N, S, P, or halogen, between linker moieties (e.g., alkyl-O-alkyl, alkyl-S-alkyl, etc.).

A sulfonic acid group can be covalently bonded to surface 111 in a variety of ways.

In some embodiments, a sulfonic acid group can be directly covalently bonded to surface 111 by reacting one or more surface carbons of surface 111 with chlorosulfonic acid as depicted in the reaction scheme below:
C—H+ClSO₃H→C—SO₃H+HCl.

The degree of sulfonation can generally be controlled by modifying appropriate reaction conditions, such as, for example, the length of reaction time, reaction temperature, concentration of reagents, and solvent. As an example, if a high degree of sulfonation is desired, surface 111 can be treated with neat or concentrated chlorosulfonic acid. As another example, if a lower degree of sulfonation is desired, surface 111 can be treated with dilute chlorosulfonic acid (e.g., chlorosulfonic acid diluted in an organic solvent such as dichloromethane or acetic acid).

Other reagents can also be used to covalently bond a sulfonic acid moiety to a carbon containing cathode flow field plate 110. For example, cathode flow field plate 110 can be treated with sulfuric acid (e.g., fuming sulfuric acid), chloromethylsulfonic acid, or other chemical species that can react with surface 111 to provide a sulfonic acid group covalently bonded to surface 111.

In general, the presence of the sulfonic acid groups on the surface of plate 110 increases the hydrophilicity of plate 110. As an example, in some embodiments, the initial contact angle of a cathode flow field plate with water after covalently bonding the sulfonic acid moiety is at least about 20% less (e.g., at least about 25% less, at least about 30% less) than the initial contact angle of the cathode flow field plate with water before covalently bonding the sulfonic acid moiety. As another example, in certain embodiments, the initial contact angle of a cathode flow field plate 110 with water after covalently bonding the sulfonic acid moiety is at least about 15° less (e.g., at least about 20° less, at least about 25° less) than the initial contact angle of the cathode flow field plate with water before covalently bonding the sulfonic acid moiety.

In some embodiments, the portion of plate 110 having the sulfonic acid covalently bonded thereto has an initial contact angle with water that is less than about 75° (e.g., less than about 70°, less than about 65°, less than about 62°). The contact angle of the surface of an article with water is measured as described below.

In certain embodiments, the portion of plate 110 having the sulfonic acid covalently bonded thereto has an initial contact angle with diiodomethane that is less than about 40° (e.g., less than about 35°, less than about 30°, or less than about 28°). The contact angle of the surface of an article with diiodomethane is measured as described below with respect to measuring the contact angle of an article with water, except that diiodomethane is substituted for the water in the measurement.

Typically, anode flow field plate 120 is formed of a carbon material (e.g., graphite, such as porous graphite or nonporous graphite).

Electrolyte 130 should be capable of allowing ions to flow therethrough while providing a substantial resistance to the flow of electrons. In some embodiments, electrolyte 130 is a solid polymer (e.g., a solid polymer ion exchange membrane), such as a solid polymer proton exchange membrane (e.g., a solid polymer containing sulfonic acid groups). Such membranes are commercially available from E.I. DuPont de Nemours Company (Wilmington, Del.) under the trademark NAFION. Alternatively, electrolyte 130 can also be prepared from the commercial product GORE-SELECT, available from W.L. Gore & Associates (Elkton, Md.).

Catalyst 140 can be formed of a material capable of interacting with hydrogen to form protons and electrons. Examples of such materials include, for example, platinum, platinum alloys, such as platinum-ruthenium, and platinum dispersed on carbon black. Catalyst 140 can further include an electrolyte, such as an ionomeric material, e.g., NAFION, that allows the anode to conduct protons. Alternatively, a suspension is applied to the surfaces of diffusion layers (described below) that face electrolyte 130, and the suspension is then dried. In some embodiments, a catalyst material (e.g., platinum) can be applied to electrolyte 130 using standard techniques. The method of preparing catalyst 140 may further include the use of pressure and temperature to achieve bonding.

Catalyst 150 can be formed of a material capable of interacting with oxygen, electrons and protons to form water. Examples of such materials include, for example, platinum, platinum alloys, and noble metals dispersed on carbon black. Catalyst 150 can further include an electrolyte, such as an ionomeric material, e.g., NAFION, that allows the cathode to conduct protons. Catalyst 150 can be prepared as described above with respect to catalyst 140.

In general, diffusion layers 160 and 170 are electrically conductive so that electrons can flow from catalyst 140 to flow field plate 120 and from flow field plate 110 to catalyst 150. GDLs can be formed of a material that is both gas and liquid permeable. It may also be desirable to provide the GDLs with a planarizing layer, for example, by infusing a porous carbon cloth or paper with a slurry of carbon black followed by sintering with a polytetrafluoroethylene material. Suitable GDLs are available from various companies such as Etek in Somerset, N.J., SGL in Valencia, Calif., and Zoltek in St. Louis, Mo.

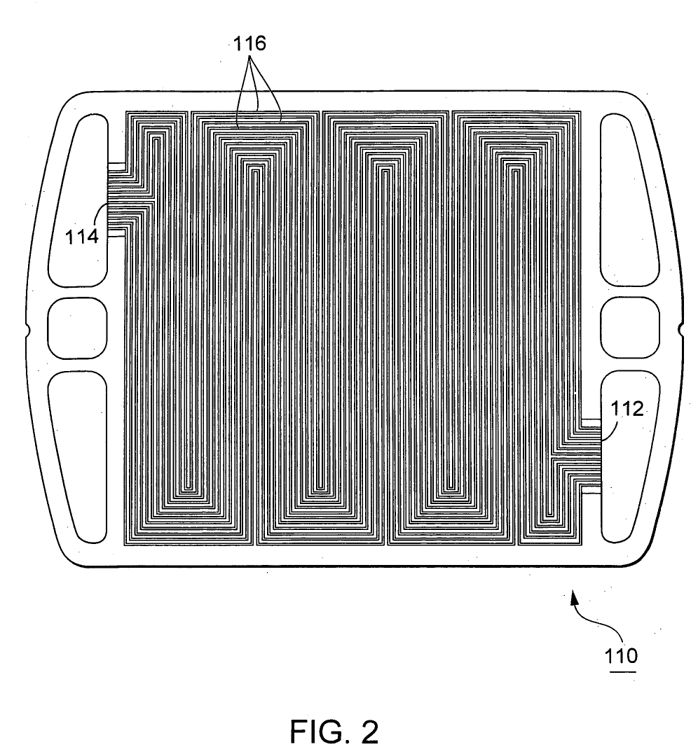

FIG. 2 shows an embodiment of cathode flow field plate 110, which is used to provide a flow path that allows the molecular oxygen to interact with catalyst 150 during use of fuel cell 100. Cathode flow field plate 110 has an inlet 112, an outlet 114 and open-faced channels 116 that define a flow path for an oxidant from inlet 112 to outlet 114. As the oxidant flows along channels 116, the molecular oxygen contained in the oxidant permeates diffusion layer 170 to interact with catalyst 150, electrons and protons to form water. The water can pass back through diffusion layer 170, enter the oxidant stream in channels 116, and exit fuel cell 100 via outlet 114.

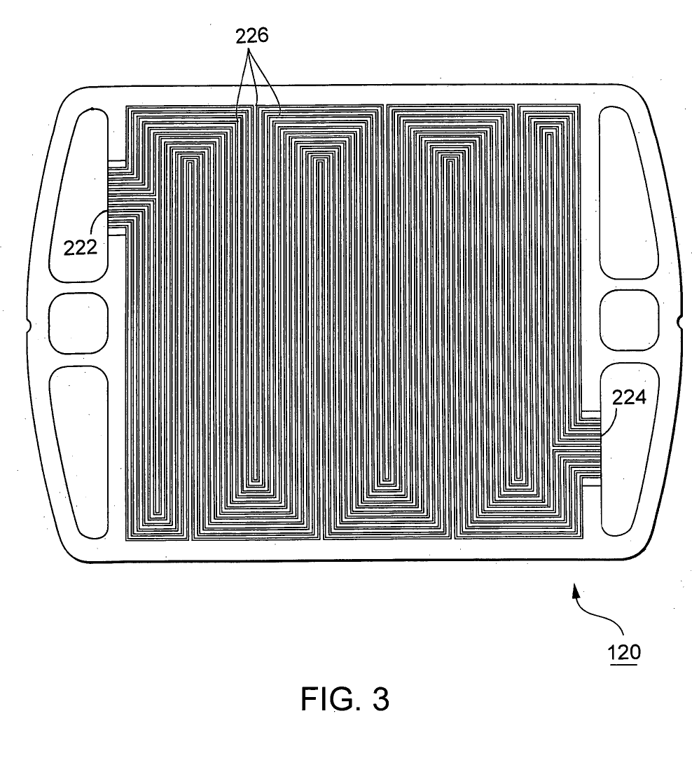

FIG. 3 shows an embodiment of anode flow field plate 120, which is designed to provide a flow path for a fuel that allows the molecular hydrogen to interact with catalyst 140 during use of fuel cell 100. Anode flow field plate 120 has an inlet 222, outlet 224 and open-faced channels 226 that define a flow path for a fuel from inlet 222 to outlet 224. The protons pass through solid electrolyte 130, and the electrons are conducted through diffusion layer 160 to anode flow field plate 120, ultimately flowing through an external load to cathode flow field plate 110. The unreacted fuel exits fuel cell 100 via outlet.

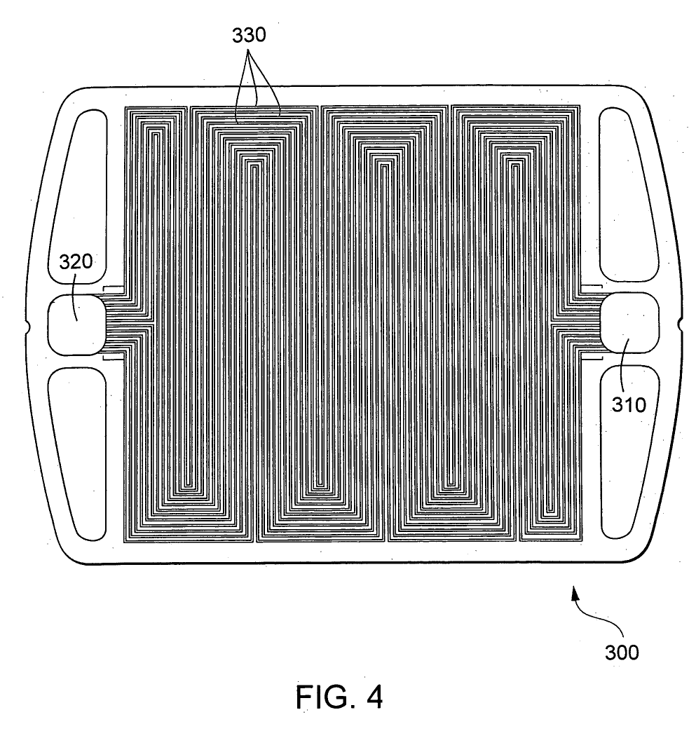

The heat produced during the fuel cell reaction can be removed by flowing a coolant through the fuel cell via a coolant flow field plate. FIG. 4 shows an embodiment of a coolant flow field plate 300 having an inlet 310, an outlet 320 and open-faced channels 330 that define a flow path for coolant from inlet 310 to outlet 320. The coolant enters fuel cell 100 via inlet 310, flows along channels 330 and absorbs heat, and exits fuel cell 100 via outlet 320.

The following examples are illustrative and not intended to be limiting.

### EXAMPLES

A piece of graphite composite plate (2.0 cm×11.0 cm) was sulfonated under the following conditions: 5 times dilution of chlorosulfonic acid by dichloromethane, 5-minute contact time between this diluted mixture and the plate at room temperature.

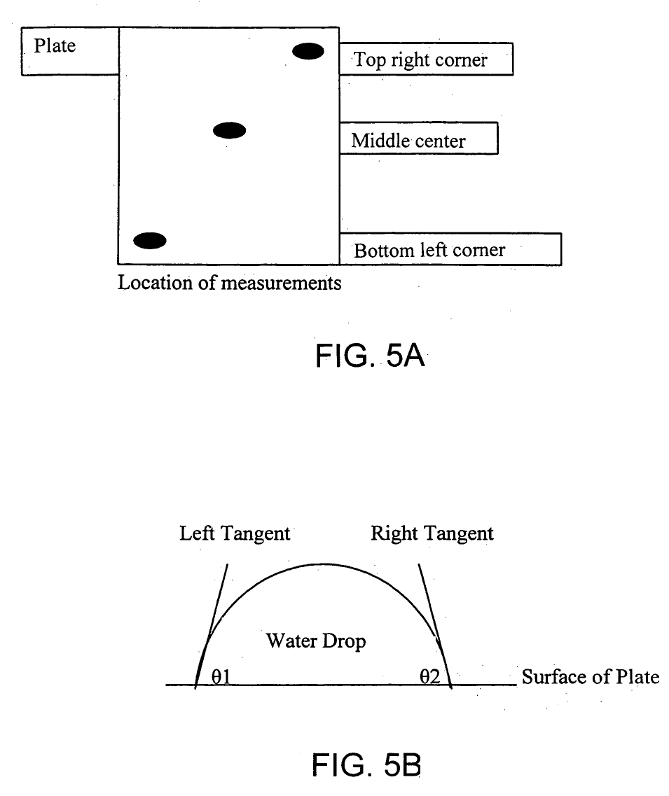

The contact angle measurement was performed using a Rame-Hart Goniometer Model # 100-00 by following ASTM D724-99: standard test method for surface wettability of paper. The plate was measured using three water drops purposely applied onto the top right corner, middle center, and bottom left corner (See FIG. 5a). Each angle was an average of the left contact (θ1) and right contact (θ2) of the water drop with the plate (See FIG. 5b).

Table 1 shows results averaged from the three different locations for the graphite composite plate before and after sulfonation at different times. Initial refers to a measurement. that was taken less than one minute from the moment the water drop was laid onto the plate. Two subsequent measurements were taken at 5 and 15 minutes, respectively.

TABLE 1
Measurements of Contact Angle

| | Contact Angle (°) | | |
|---|---|---|---|
| Plate | | 5 minutes | 15 minutes |
| Conditions | Initial | later | later |
| Unsulfonated | 85 | 77 | 57 |
| Sulfonated | 60 | 48 | 6 |

The initial contact angles were 85° and 60° for the original and sulfonated plates, respectively, demonstrating that covalently bonding the sulfonic acid moiety increased the hydrophilicity of the surface. While the contact angles decreased with time for both sulfonated and unsulfonated plates, the decrease was greater for the sulfonated plate.

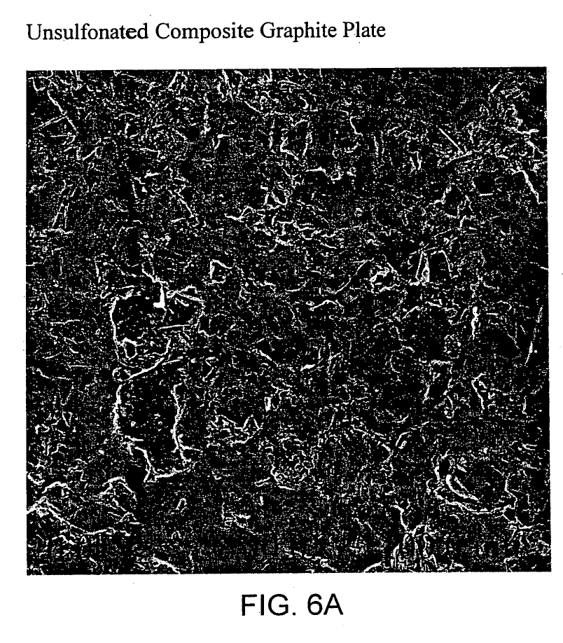

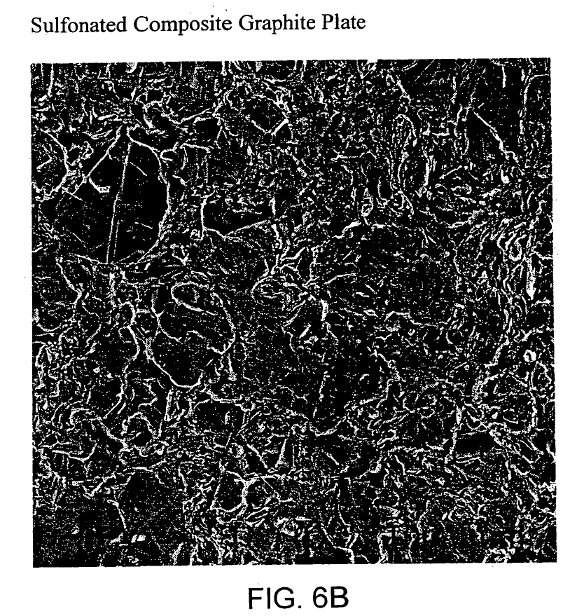

Scanning Electron Microscopy (SEM) was performed using a JEOL 6400 SEM with an IXRF 500 EDS Digital Processor to examine if the surface morphology of the plate was changed after sulfonation. Referring to FIGS. 6a and 6b, the sulfonated plate appeared rougher than the unsulfonated counterpart. Without wishing to be bound by theory, it is believed that a possible explanation for the change in surface morphology is that some the resin at the surface of the plate was modified or destroyed by chlorosulfonic acid.

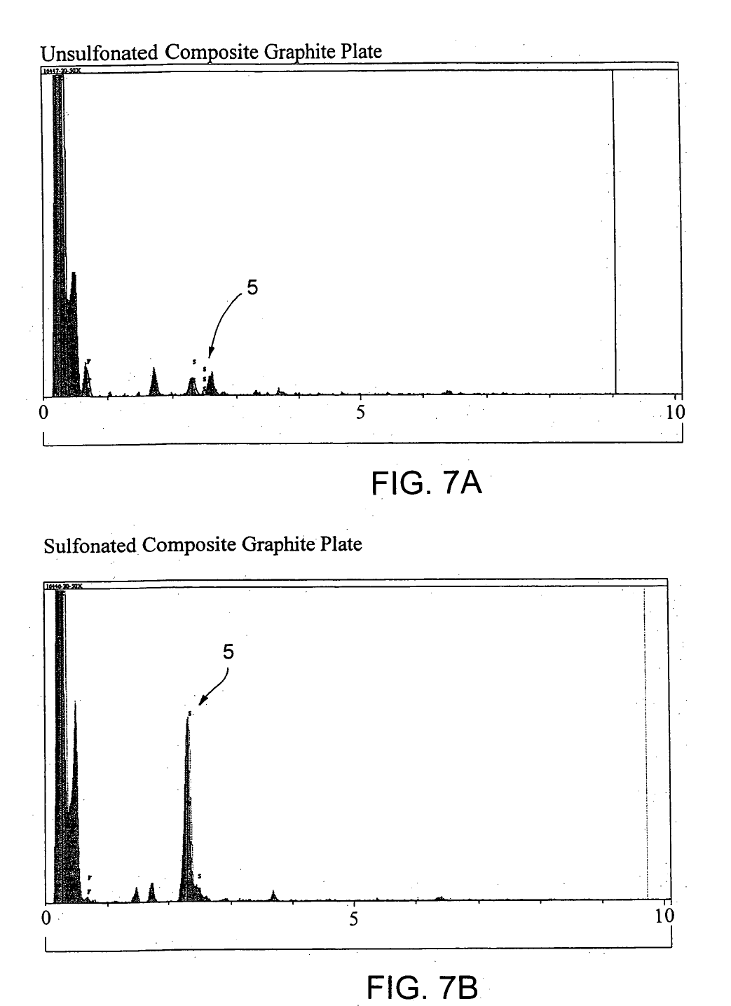

The linkage of —SOH₃ onto the plate was confirmed by X-ray emission analysis. A much larger S peak (about 10 times larger) was observed for the sulfonated plate than for the unsulfonated counterpart, as shown by the spectra in FIGS. 7a and 7b and the data in Tables 2 and 3 below.

TABLE 2
Unsulfonated Composite Graphite Plate

| | | Intensity | | |
|---|---|---|---|---|
| Element | Line | (counts/s) | Atomic % | |
| C | Ka | 691.77 | 98.529 | |
| F | Ka | 11.99 | 1.376 | |
| S | Ka | 10.09 | 0.094 | |
| | | | 100.000 | Total |

TABLE 3
Sulfonated Composite Graphite Plate

| | | Intensity | | |
|---|---|---|---|---|
| Element | Line | (counts/s) | Atomic % | |
| C | Ka | 608.11 | 98.878 | |
| F | Ka | 2.73 | 0.270 | |
| S | Ka | 107.50 | 0.852 | |
| | | | 100.000 | Total |

While certain embodiments have been described, other embodiments are possible.

As an example, while covalently bonding a sulfonic acid moiety has been described with respect to the surfaces of the channel portions of a cathode flow field plate, other portions of a cathode flow field plate can also have a sulfonic acid moiety covalently bonded thereto. In certain embodiments (e.g., when the flow field plate is formed of a porous material, such as porous graphite), a sulfonic acid moiety may be covalently bonded within pores in the plate. In some embodiments, surfaces 117 of the lands of the cathode flow field plate can have a sulfonic acid moiety covalently bonded thereto. It is to be noted that, in such embodiments, the sulfonic acid moiety does not substantially impede the flow of electrons within the fuel cell. In some embodiments, at least about 90% (e.g., at least about 95%, at least about 97%) of the surface area of a cathode flow field plate has sulfonic acid moiety covalently bonded thereto.

As another example, while covalently bonding a sulfonic acid moiety has been described with respect to cathode flow field plates, a sulfonic acid moiety can also be covalently bonded to an anode flow field plate and/or a coolant plate.

As a further example, while flow field plates have been described as being formed of carbon materials, other materials can also be used.

As an additional example, while proton exchange fuel cells have been described, other fuel cells can also be used. Examples of fuel cells include solid oxide fuel cells and direct-feed liquid fuel cells. Examples of direct-feed liquid fuel cells include direct alcohol fuel cells, such as direct methanol fuel cells, direct ethanol fuel cells and direct isopropanol fuel cells.

In some embodiments, the acidic moiety has the formula R—X, where R is as described above, and X is an acidic moiety. Examples of such acidic moieties include SO₃H, PO₃H₂, AsO₃H₂ and COOH.

The fuel cells can be used in a variety of applications, including, for example, in automobiles or stationary systems (e.g., systems designed to power a home).

Other embodiments are in the claims.

1. An article, comprising:
a fuel cell flow plate; and
a sulfonic acid moiety covalently bonded to the fuel cell flow plate,
wherein the sulfonic acid moiety has the formula RSO₃H, and R is /, an alkyl moiety, an alkenyl moiety, an alkynyl moiety, an aryl moiety, or a heteroaryl moiety.

2. The article of claim 1, wherein R is /.

3. The article of claim 1, wherein R is an alkyl moiety substituted with halogen.

4. The article of claim 1, wherein R is an aryl moiety substituted with halogen or an alkyl moiety.

5. The article of claim 1, wherein the fuel cell flow plate comprises carbon.

6. The article of claim 5, wherein the carbon comprises graphite.

7. The article of claim 1, wherein a hydrophilicity of the article is greater than a hydrophilicity of the fuel cell flow plate.

8. The article of claim 1, wherein the fuel cell flow plate is porous.

9. The article of claim 8, wherein the sulfonic acid moiety is present in pores of the fuel cell flow plate.

10. The article of claim 1, wherein the fuel cell flow plate is non-porous.

11. The article of claim 1, wherein the fuel cell flow plate is in the form of a bipolar flow plate.

12. The article of claim 1, wherein the fuel cell flow plate is in the form of a monopolar plate.

13. The article of claim 1, wherein the fuel cell flow plate is in the form of a coolant plate.

14. The article of claim 1, wherein the fuel cell flow plate has a surface area, and at least about 90% of the surface area of the fuel cell flow plate has the sulfonic acid moiety covalently bonded thereto.

15. The article of claim 1, wherein the fuel cell flow plate has a flow-field channel portion, and a surface of the flow-field channel portion is covalently bonded to the sulfonic acid moiety.

16. The article of claim 1, wherein at least a portion of a surface of the article has an initial contact angle with water that is less than about 75°.

17. The article of claim 1, wherein at least a portion of a surface of the article has an initial contact angle with diiodomethane that is less than about 40°.

18. The article of claim 1, wherein at least a portion of a surface of the article has an initial contact angle with water that is at least about 15° less than an initial contact angle with water of the fuel cell flow plate.

19. The article of claim 1, wherein at least a portion of a surface of the article has an initial contact angle with water that is at least about 20% less than an initial contact angle with water of the fuel cell flow plate.

20. A fuel cell, comprising:
a first fuel cell flow plate;
a second fuel cell flow plate;
an electrolyte between the first and second fuel cell flow plates; and
a sulfonic acid moiety covalently bonded to the first fuel cell flow plate,
wherein the sulfonic acid moiety has the formula RSO₃H, and R is /, an alkyl moiety, an alkenyl moiety, an alkynyl moiety, an aryl moiety, or a heteroaryl moiety.

21. The fuel cell system of claim 20, wherein the fuel cell system is a proton-exchange-membrane fuel cell.

22. The fuel cell system of claim 20, wherein the fuel cell system is a direct-feed liquid fuel cell.

23. The fuel cell system of claim 20, wherein the fuel cell is a direct alcohol fuel cell.

24. The fuel cell system of claim 20, wherein the fuel cell is a direct methanol fuel cell.

25. The fuel cell system of claim 20, wherein the fuel cell is a direct propanol fuel cell.

26. An article, comprising:
a fuel cell flow plate; and
an acidic moiety covalently bonded to the fuel cell flow plate, wherein:
the acidic moiety has the formula R—X;
R is /, an alkyl moiety, an alkenyl moiety, an alkynyl moiety, an aryl moiety, or a heteroaryl moiety; and
X is selected from the group consisting of SO₃H, PO₃H₂, AsO₃H₂ and COOH.
